(19) United States
(12) Patent Application Publication
(10) Pub. No.: US 2009/0034433 A1
(43) Pub. Date: Feb. 5, 2009

(54) Method for Rebuilding an Ad Hoc Network and the Nodes Thereof

(75) Inventors: Gabriel Chegaray, Noyal-Sur-Vilaine (FR); Eric Villain, Noyal-Sur-Vilaine (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 12/086,119

(22) PCT Filed: Dec. 1, 2006
(86) PCT No.: PCT/FR2006/002632

§ 371 Date: Oct. 8, 2008

(30) Foreign Application Priority Data
Dec. 5, 2005 (FR) 0512307

(51) Int. Cl. H04L 12/28

(52) U.S. Cl. 370/255

(57) ABSTRACT

The invention relates to a method for rebuilding an ad hoc network, in particular a ZigBee-type network consisting (A) in collecting data of the network nodes in terms of quality of connections and non-optimal network trees, (B) in calculating a current optimised structure, (D) in setting optimisation data and injecting them into the network and (E) in rebuilding the network according to said current optimised structure.

The invention relates to a method of rebuilding an ad hoc network, notably a ZigBee-type network, and to the corresponding network nodes.

The purpose of an ad hoc network is to connect potentially mobile communicating entities, outside any preexisting infrastructure in spontaneous networks. Each entity communicates directly with its neighbors, each being able to act as client, server and router.

The ZigBee networks comply with a wireless data transmission standard, the IEEE 802.15.4 standard, enabling machine-to-machine communication. Besides their great usage versatility, these networks are characterized by a very low electrical consumption and very low production costs which, for a range of between 30 meters and 100 meters and a data transfer rate of between 20 and 250 kbit/s, means they are reserved for home automation applications or for sensor or remote control hardware or for control equipment in the industrial sector.

In the abovementioned ZigBee networks, the addressing of the network nodes is constructed either from a hierarchical address distribution technique, according to a tree building procedure based on initial parameters of the tree, or by allocation of address blocks, managed at application level according to an unspecified process, which can be a centralized agent for distributing address blocks.

The address block allocation process has the advantage of being well suited to the addressing needs of the routers.

It does, however, present the drawback of being complex, of offering no help for routing and of presenting a weakness when, in particular, a centralized address block distribution agent is used.

At the present time, the abovementioned process has not been implemented by any network provider.

The process based on the hierarchical address distribution technique presents the drawback, when the parameters of the tree have been set, of obeying static rules and therefore of being subject to structural limits due to the allocation process, after the ZigBee coordinator has been chosen for the network.

In particular, the number of children of a parent node of the tree is defined once and for all for the tree concerned.

However, each router can allocate addresses independently of the others and a default routing is applicable. The abovementioned process is therefore simple and is particularly suitable for networks that are small in terms of number of nodes.

Its current limits therefore concern large networks.

Various solutions have been proposed in order to remedy the abovementioned drawbacks.

A first solution involves applying a dynamic management of the parameters of the tree, node by node. Each node can determine the number of its child nodes. This solution presents the major drawback whereby the addressing is not adaptive and requires a manual configuration, for each router in turn. The proposed implementations that use this solution cannot calculate the address block (Cship) from the parameters of the latter but use tables, which can pose a major problem when the abovementioned parameters are not set.

A second solution proposes fixing the addresses for each node in turn using an appropriate installation tool.

The object of the addressing method managed at application level by means of an agent was to implement the proposal according to this second solution. However, the ultimate complexity of implementing the whole and the dependency for addressing on a third party present risks that are too great, from the point of view notably of transaction security.

A third solution recommended by G. CHEGARAY involves making the tree of the node addresses more adaptive, by tolerating exceptional outgrowths after the last level, in order to overcome the tree depth limitation.

This proposal was not adopted, because it proved too limited in its effects on the tree given the resulting ultimate complexity.

None of the abovementioned solutions has emerged as truly satisfactory, which is a major brake on the implementation of large-scale ZigBee networks.

Furthermore, in the case of the addressing of the network nodes based on a hierarchical address distribution technique, a second problem emerges, which is linked to one of the conditions of use of the ZigBee networks, whereby the user terminal and the user thereof have no knowledge of these networks, regarding installation or operation or even maintenance. The terminal and the user are then said to be agnostic regarding the communication technology.

Now, the IEEE 802.15.4 standard concerning ZigBee networks establishes a difference between coordinators and routers. Consequently, the abovementioned method offers prospects of development success only in as much as the addressing space is far bigger than the network or else in as much as the coordinator allows a fish-eye network structure, that is, a geographic centering of the ZigBee coordinator.

The abovementioned second condition in fact necessitates preliminary calculations, before the installation of the network, all the more hypothetical to carry out effectively, as it would then be necessary to presume in advance on the quality of each radio link, in order to provide the link from one router node to another router node.

Although specifically suited, in theory, to this type of link, it appears that the ZigBee networks suffer from limitations likely to prejudice its rollout with users and agnostic usage hardware.

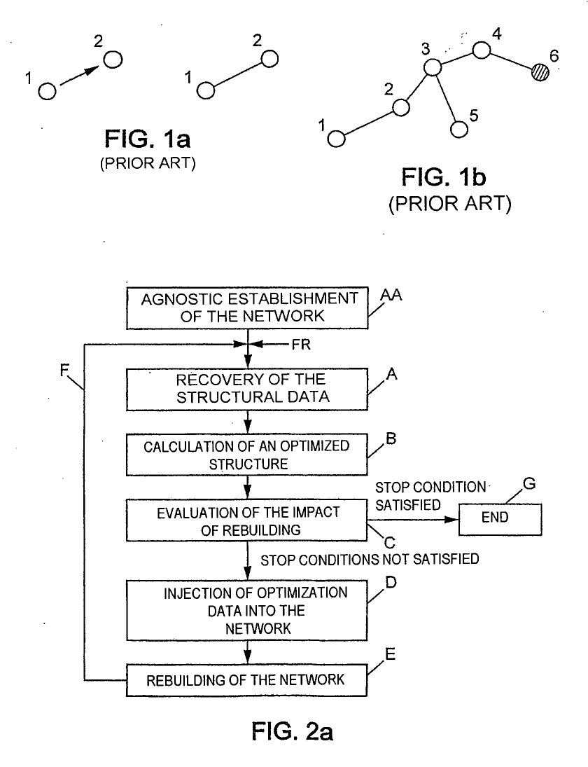

As will be observed in FIGS. 1a and 1b, the formation of a ZigBee network, involving introducing two nodes A and B into the network, the node A that is shown shaded becoming the ZigBee coordinator, as represented in FIG. 1a, then randomly adding nodes in this network, as represented in FIG. 1b, with respect to the initial coordinator node, has the effect of off-centering the latter: the ZigBee network obtained is not optimal. If the maximum depth of the ZigBee network, equal to 4 for example, is reached, it is no longer possible to add nodes after the router node of corresponding depth, shown shaded in FIG. 1b.

The object of the present invention is to remedy all or some of the abovementioned drawbacks concerning ad hoc networks, notably of ZigBee type, of the prior art.

In particular, the object of the present invention is to implement a method and a device for rebuilding an ad hoc network that makes it possible to calculate and establish a structure that is optimized in terms of extensibility and transmission of communications between the nodes of the network.

The method of rebuilding an ad hoc network that is the subject of the invention is noteworthy in that it includes at least: the collection of data from the nodes of this network, in terms of quality of the links and trees of the nodes defining a structure of this non-optimal network, calculation of a current optimized structure from this structure of this non-optimal network, evaluation, relative to a stop value, of the impact of the current optimized structure on the structure of this non-optimal network, and, if this stop value is not reached by the value of this impact, the current optimized structure defining a pseudo-optimized structure of this non-optimal network, establishment and injection of optimization data into this network, rebuilding of this network according to the current optimized structure and the iterative return to the collection of data from the nodes of this network and the succession of calculation, evaluation, establishment and rebuilding steps as long as this stop value is not reached by the impact value; otherwise, if this stop value is reached by this impact value, stopping of the rebuilding method, the non-optimal network being allocated the current optimized structure obtained on the last iteration, this non-optimal network thus being optimized.

The method of rebuilding an ad hoc network and the corresponding network node can be applied to implementing the optimization of ad hoc networks.

It will be better understood from reading the description and studying the drawings below, in which, besides FIGS. 1a and 1b relating to the prior art,

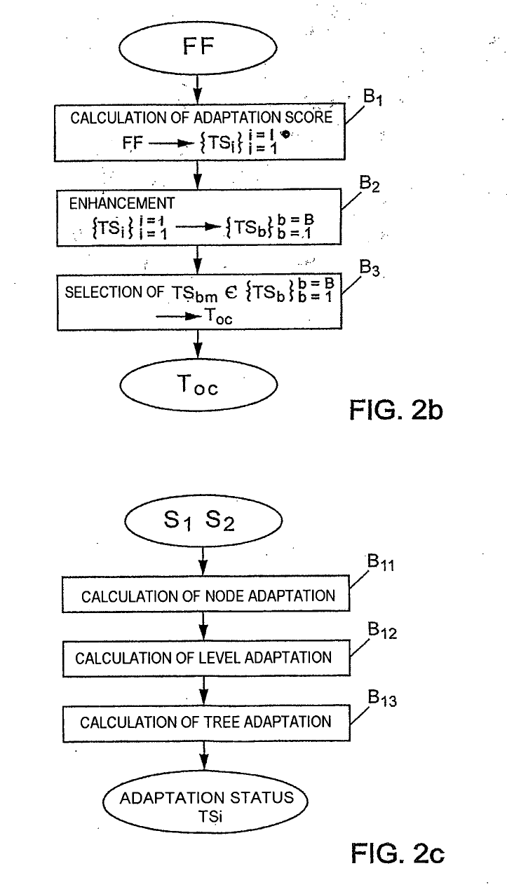

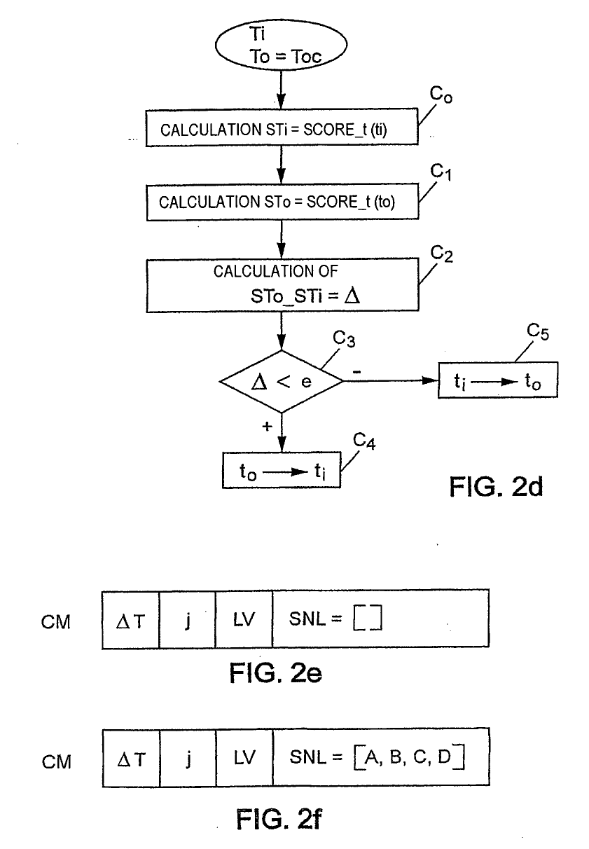

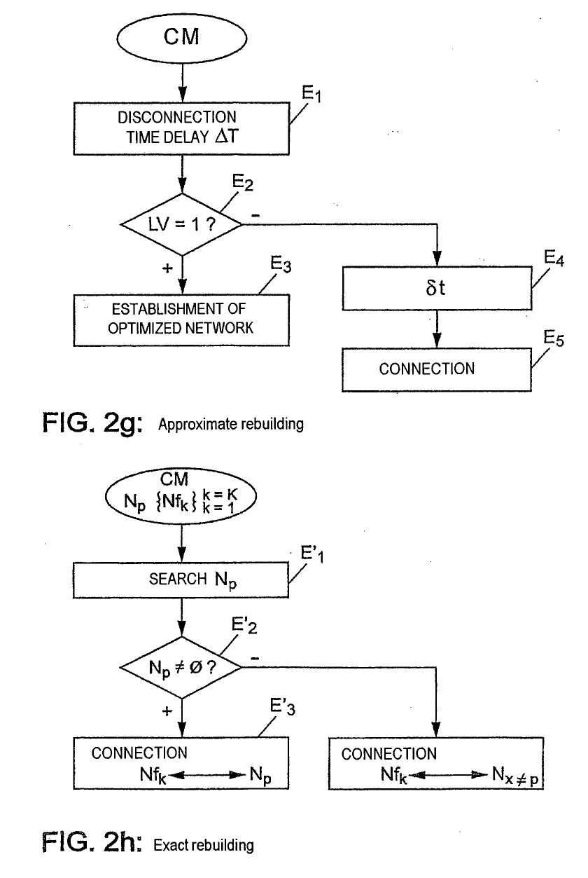

FIG. 2a represents, by way of illustration, a flow diagram of the main steps in implementing the method that is the subject of the invention;

FIG. 2b represents, by way of illustration, a detailed method of implementing the optimized structure calculation step B of FIG. 2a;

FIG. 2c represents, by way of illustration, a preferred but nonlimiting way of implementing the calculation of the adaptation score of a network tree from an adaptation function, according to the step B1 of FIG. 2b;

FIG. 2d represents, by way of illustration, a detailed method of implementing the rebuilding impact evaluation step C of FIG. 2a;

FIG. 2e represents the structure of a command message transmitted to each node of the network, in the case of an approximate rebuilding;

FIG. 2f represents the structure of a command message transmitted to each node of the network in the case of an exact rebuilding;

FIG. 2g represents the process implemented by each of the nodes of the network in the step E of FIG. 2a, in the case of an approximate rebuilding;

FIG. 2h represents the process implemented by each of the nodes of the network in the step E of FIG. 2a in the case of an exact rebuilding;

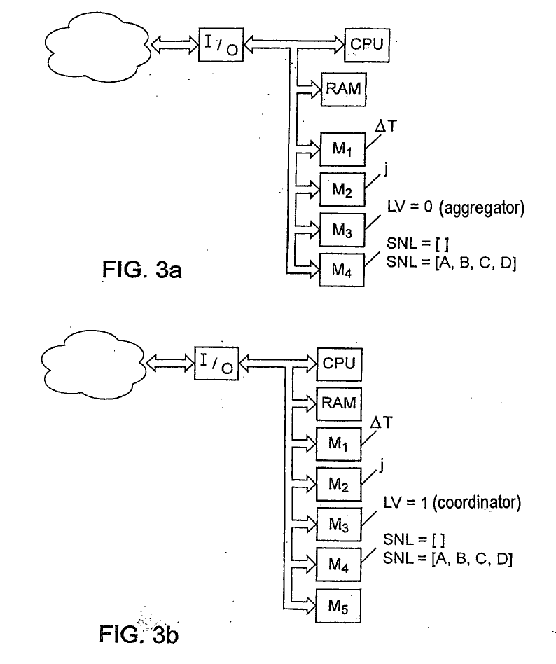

FIG. 3a represents, by way of illustration, a ZigBee network node, acting as aggregator, making it possible to implement the method that is the subject of the present invention, according to an approximate or exact rebuilding;

FIG. 3b represents, by way of illustration, a ZigBee network node, acting as coordinator, making it possible to implement the method that is the subject of the present invention, according to an approximate or exact rebuilding.

A more detailed description of the method of rebuilding a network, such as a non-optimal ZigBee network, in accordance with the subject of the present invention will now be given in conjunction with FIG. 2a and the subsequent figures.

Referring to the abovementioned figure, it should be indicated that the method that is the subject of the invention can be implemented either by establishing, by an agnostic establishment, a ZigBee network in the step AA of FIG. 2a, or, on the other hand, in the absence of such an establishment step on an existing, non-optimal ZigBee network.

It will also be recalled that the step AA for agnostic establishment of the network or, ultimately, the agnostic establishment of a ZigBee network independently of the implementation of the method that is the subject of the invention consists in fact in allowing the network to be established with the default addressing system as and when new nodes are added to the network. The network that is obtained is thus a non-optimal network in both cases.

Referring to the abovementioned figure, the method that is the subject of the invention then consists, in a step A, in collecting data from the nodes of the network, in terms of link quality and node trees defining a structure of the non-optimal network. This step is denoted structural data recovery step in FIG. 2a.

The abovementioned step A is followed by a step B for calculating a current optimized structure from the abovementioned non-optimal network structure, recovered in the step A.

The step B is in turn followed by a step C for evaluating, relative to a specific stop value, the impact of the current optimized structure with respect to the non-optimal network structure.

If the stop value is not reached by the abovementioned impact value, the current optimized structure then defines a pseudo-optimized structure of the network and the method is continued with a step D for establishing and injecting optimization data into the network.

The method that is the subject of the invention is then continued with a step E for rebuilding the network according to the current optimized structure previously calculated in the step B.

According to a noteworthy aspect of the method that is the subject of the invention, the step E is in turn followed by a step F for iteratively returning to the collection of data from the nodes of the network in the step A, followed by the succession of the steps for calculating an optimized structure B, evaluating the impact of the rebuilding C, injecting the data into the network D, then successively rebuilding E, as long as the stop value is not reached by the impact value evaluated in the step C.

Otherwise, when the stop value is reached by the impact value, the method is continued with the stopping of the latter in the step G.

In this situation, the network is allocated the current optimized structure obtained on the last iteration, since the network is thus optimized.

As represented in FIG. 2a, the method that is the subject of the invention also comprises a step for automatically triggering the first iteration, this step being denoted FR in FIG. 2a. The abovementioned automatic triggering step is executed on detection of a false distribution signal from a router or on detection of a false distribution signal from an equipment item.

The automatic triggering step thus allows for a triggering either on a startup ordered by an operator, for example on commissioning the network or during a maintenance operation, or on detection of a bad distribution signal from a router or an equipment item.

A bad distribution signal from a router is generated by a router which has the facility to connect to the network, but which is in one of the following situations:

either the router concerned is connected to the last level of the tree, a level corresponding to the maximum depth of the tree representing the structure of the network;

or it is connected as terminal equipment, because of not being able to find a free location as a router at a lower level than the depth of the tree.

The abovementioned two cases correspond to situations where the router cannot fulfill its aggregator role.

The triggering of such a signal is optional.

A bad distribution signal from an equipment item is generated when the equipment item concerned deems it appropriate. For example, if the equipment item needs to dialog with another equipment item which cannot be found in the network, it can estimate that the cause originates from a bad topology of the network and trigger the abovementioned signal.

The step A for collecting data from the nodes of the network comprises at least discovery, by scanning the network, to recover the address of all the aggregator nodes present in the network and the links seen by each aggregator node in the neighborhood tables of the abovementioned aggregator nodes.

The data collection step also comprises the creation of a first data structure containing all the nodes and all the links for each node, accompanied by the quality value of each link, and a second data structure restoring the addressing structure of the nodes and their parent node/child node relationships, this addressing structure corresponding to the node tree that forms the network and representing the image of the structure and of the network concerned.

The step B for calculating a current optimized structure will now be described in conjunction with FIGS. 2b and 2c.

To implement the step B for calculating an optimized structure, there is an adaptation function FF that can be used to calculate an adaptation value of all or part of the network, as will be described hereinbelow.

The calculation of a current optimized structure comprises at least, as represented in FIG. 2b, the calculation in a step B₁ of a specific adaptation score based on the adaptation function FF for all or part of the current optimized structure in the search space of the solution formed by the table of the links involved between all the nodes of the network.

In the step B₁ of FIG. 2b, the specific score calculation operation is denoted:

FF→{TSᵢ}ᵢ₌₁^{i=I}.

The abovementioned operation makes it possible to create a population of individuals formed by a plurality of optimized structures, with each of which is associated a specific adaptation score TSᵢ.

The step B₁ is followed by a step B₂ for enhancing the population {TSᵢ}ᵢ₌₁^{i=I} on a specific individual discrimination criterion for generating an enhanced population.

In the abovementioned step B₂, the enhancement operation is denoted:

{TSᵢ}ᵢ₌₁^{i=I}→{TS_{b}}_{b=1}^{b=B}

where {TS_{b}}_{b=1}^{b=B} denotes all the scores relating to the abovementioned enhanced population.

The step B₂ is followed by a step B₃ consisting in selecting from the enhanced population {TS_{b}}_{b=1}^{b=B} a specific structure corresponding to the best adaptation score, the best adaptation score being denoted TS_{bm} and the selection operation being denoted in FIG. 2b:

TS_{bm}ε{TS_{b}}_{b=1}^{b=B}

The specific structure showing the best adaptation score TS_{bm} corresponding to the current optimized structure is denoted T_{oc}.

Regarding the adaptation function FF, this will be described from the point of view of its implementation in relation to FIG. 2c. For any current optimized network tree structure for example, as for the initial non-optimal network, there are the first and the second data structures S₁ and S₂ relating to the node tree, with parent-child relationships to create the image of the current structure of the network.

As represented in FIG. 2c, the adaptation function FF and the calculation of the latter can advantageously include the calculation of an adaptation score for each node of the network structure in the step B₁₁ of FIG. 2c in the following conditions.

For any node N of a ZigBee network, the value of the adaptation score is defined according to the relation:

$$score\_n ( N ) = {\sum }_{i = 0}^{nb\_neighbors ( N )} lqi ( {V}_{i} ( N ) ) .$$

In the above relation, nb_neighbors is the number of neighboring nodes of the node concerned N.

Furthermore, lqi(V) is a function which depends on the value of the radio link quality with respect to a neighboring node concerned, link quality being denoted by LQI, standing for Link Quality Indicator.

As an example, for LQI denoting the measured value of the link quality between the node N and a neighbor V, the link quality function lqi(V) can be taken to be equal to

lqi(V)=LQI+r(LQI).

In the above relation, r(LQI) is a function of the link quality LQI which can be used to prioritize the most effective radio links. For example, r(LQI)=R is a constant value when LQI>x, x being a value from which it is considered that the radio link is effective and r(LQI)=0 otherwise.

The substep B₁₁ of FIG. 2c is then followed by a substep B₁₂ consisting in calculating an adaptation score for each depth level of the structure of the network and of the tree represented by the latter, by aggregating the adaptation score of each node of one and the same level.

In these conditions, for a depth d of the tree representative of the structure of the network, the adaptation score of each level is given by the relation:

$$score\_l ( d ) = \frac{1}{{a}^{d}} {\sum }_{i = 0}^{nb\_nodes ( d )} score\_n ( N ( i ) ) .$$

In the above relation, nb_nodes denotes the number of nodes belonging to the depth level concerned; a is a constant, a>1, determined according to the desired final topology of the optimized network as will be described later in the description.

The substep B₁₂ is then followed by a substep B₁₃ consisting in calculating an adaptation score of the tree formed by the network by aggregating the adaptation score of each depth level of the tree forming the network concerned.

For a tree t, t is an individual of the search space for which the adaptation score satisfies the relation:

$$score\_t ( t ) = {\sum }_{d = 0}^{depth ( t )} \frac{1}{{a}^{d}} ( {\sum }_{i = 0}^{nb\_node ( d )} score\_n ( N ( i ) ) ) .$$

By implementing the abovementioned adaptation function FF and the procedure for calculating the latter, it is thus possible to calculate the adaptation value of an entire current optimized network, or of the initial agnostic network, as well as, naturally, a subtree of the latter or a branch forming a determined subtree. In any case, an optimized structure of a ZigBee-type network presenting the best adaptation value can then be selected as described previously in the description as optimum for the network concerned.

A more detailed description of the implementation of the step C for evaluating the impact of the rebuilding will now be given in conjunction with FIG. 2d.

For the implementation of the abovementioned step, there is, referring to FIG. 2d, the network tree structure, this tree being denoted tᵢ, which can correspond to the initial non-optimal network and, after the first iteration, the current optimized tree structure t₀=T_{oc}.

As represented in FIG. 2d, in a substep C₀, the adaptation score of the tree in place in the network, the tree tᵢ, is calculated, that is, the score STᵢ=score_t(tᵢ) is calculated.

In the next substep C₁, the score ST₀=score_t(t₀) is calculated for the current optimized structure.

In the substep C₂, the difference ST₀−STᵢ=Δ is calculated, this being the difference in adaptation between the tree structure that is in place and the current optimized tree structure.

The substep C₂ is followed by a substep C₃ consisting in comparing the adaptation difference Δ with a value e, e being a deviation from which the adaptation difference is considered to be significant.

On a positive response to the substep C₃, that is, if the adaptation difference is smaller than the deviation value e, then a decision is made to retain, as the tree in place in the network, the latter. This operation is denoted, in the substep C4 of FIG. 2d:

t₀→tᵢ.

Otherwise, on a negative response to the substep C₃, the decision is to prefer the current optimized tree structure to that existing in the network.

This operation in the substep C₅ is denoted:

tᵢ→t₀.

In step C for evaluating the impact of the rebuilding of FIG. 2a, it is indicated that the stop value is a value dependent on the deviation between an adaptation score of the image of the network structure and an adaptation score of the current optimized structure.

In particular, the condition Δ<e of the substep C₃ of FIG. 2d in fact represents a stop condition.

If several iterations have been made for the rebuilding of the network, it is then possible to impose a limit N on the number of iterations, which can, if necessary, constitute another stop condition.

In these conditions, the stop value is a number of calculation iterations N.

Regarding the step D for injecting optimization data into the network of FIG. 2a, it is indicated that this step can be performed either for an approximate rebuilding of the network, or, on the other hand, for an exact rebuilding.

A more detailed description of the step D for injecting optimization data into the network as represented in FIG. 2a will now be given in conjunction with FIGS. 2e and 2f.

Referring to FIG. 2e for an approximate rebuilding of the network, the establishment and the injection of optimization data involves transmitting to each node of the network a command including at least, as represented in FIG. 2e, a time delay ΔT before disconnecting this node from the network, an order number j for the rebuilding of the network, and a variable LV representing the router, aggregator or coordinator function or role of the node concerned. As a nonlimiting example, it should be indicated that the variable LV can be a logic variable of value 1 for the coordinator role and of value 0 for the router role.

In the case of approximate rebuilding, the command message represented in FIG. 2e also includes another field denoted SNL comprising an empty list SNL=[ ], that is, a list containing no elements. The abovementioned list corresponds to the list of child nodes of the node concerned. When this list is empty, as represented in FIG. 2e, the node N concerned has no children and is therefore considered as a node with no descendants.

On the other hand, for an exact rebuilding of the network, the command message, as represented in FIG. 2f, transmitted to the node concerned N, also includes information containing the list of the child routers of the recipient node, the node N, which then constitutes a parent node in the current optimized structure for all the child nodes in the list.

In FIG. 2f, it is thus considered that the list of child routers comprises the list of routers SNL=[A, B, C, D] where A, B, C, D represent an identifier or the address of each of the child nodes associated with the parent node N that are recipients of the command message.

The rebuilding process of the step E of FIG. 2a will now be described in the case of an approximate rebuilding in conjunction with FIG. 2g, respectively of an exact rebuilding in the case of FIG. 2h.

Referring to FIG. 2g in the case of an approximate rebuilding, on receipt of the command CM by each node, the node concerned, in a step E₁, observes the time delay ΔT before any disconnection.

If the node concerned is assigned a coordinator role, this condition being executed by the equality test E₂, LV=1? of FIG. 2g, the node, in a step E₃, establishes the optimized network from the non-optimal network. Otherwise, that is, on a negative response to the test E₂ of FIG. 2g, the node concerned being assigned an aggregator role LV=0, the node concerned observes another time delay δt in the test E₄ of FIG. 2g, then connects as router in the step E₅ of connection proper represented in FIG. 2g.

In the case of an exact rebuilding of the network, there is, on each node concerned, the list of child nodes of the latter. Thus, each parent node Np and all the child nodes associated with the latter Np{NFk}ₖ₌₁^{k=K} are known. Each parent node thus has the address of its preregistered child nodes.

When they are activated, after a predetermined delay, each node, considered as a child node of an existing parent node, searches for the parent node with which it is preregistered as a child node, this substep being designated E′₁ in FIG. 2h and designated Search Nₚ, where Nₚ denotes the parent node of the child node concerned.

On a successful search and identification, that is, on a positive response to the test of the substep E′₂ denoted Np≠Ø?, each child node in the substep E′₃ connects to the parent node concerned according to the following relation:

Connection Nfₖ [symbol] Nₚ.

Otherwise, on a negative response to the substep E′₂ of FIG. 2h, in the absence of a response from the parent node Nₚ to the search executed by the child node Nfₖ concerned, each of the abovementioned child nodes Nfₖ connects to another node of the network by an association procedure in the substep E′₄ of FIG. 2h.

The connection operation is denoted:

Connection Nfₖ [symbol] N_{x≠p}.

The procedure for connection as a child node of another node, different from the parent node Nₚ, as described in the substep E′₄ of FIG. 2h, enables the abovementioned child node not to remain an orphan.

Finally, in the case of FIG. 2g, the time delay δt introduced in the step E₄ corresponds to a delay more or less proportional to the connection rank j contained in the message CM.

Various indications will now be given regarding the implementation of the method that is the subject of the present invention. The method of rebuilding a ZigBee-type network, in accordance with the subject of the present invention, makes it possible to optimize the performance and the extension of the network at the edges, which helps to reduce the depth of the latter.

In particular, the calculation of the adaptation function is based on the following assumptions:

the better the radio links between nodes, the better the parent/child link of the tree and of the association of the corresponding nodes;

the fewer hops there are between two nodes, the more efficient the communication;

the more the depth is limited, the more chance the network has of being extended at the edges and the fewer hops there are, which enhances the performance of the optimized network.

Furthermore, the method that is the subject of the invention makes it possible to favor the quality radio links.

In practice, assuming a star topology, it is advantageous to favor the better quality radio links.

The method that is the subject of the invention also makes it possible to favor the completeness of the tree at each level, that is, the influence of the parameter a described previously in the description in conjunction with the description of the method of implementing the adaptation function FF.

In particular, it makes it possible to penalize the network tree structure which creates long branches and favor the completeness of the levels of the tree as the level depth increases by applying the coefficient 1/aⁿ with a>1.

The influence of the parameter a is as follows:

if a=1, then only the quality of the radio links is taken into account;

if a is great, then the level n is very highly valued compared to the level n+1, which means that solutions that would better distribute the parent/child relationships will not be advantaged.

For a=Rₘ, the weighting of each level is balanced, such that a complete tree in which all the radio links are equivalent presents the same weighting at each level. The following property is then obtained: the node having the most child routers will be the root of the tree having the best adaptation value. This value is then an extreme value.

Consequently, it can be concluded that the value of a can be chosen between 1≦a≦Rₘ.

The choice of the value a=Rₘ/2 is recommended.

The method that is the subject of the invention also makes it possible to implement an optimization of performance and balance.

In practice, it is possible to take into account various criteria, given the following assumptions:

the better the radio links, the better the parent/child link of the tree;

the more balanced the tree, the easier it is for a router node to connect to the network and the more the loads are distributed between the constituent nodes of the network;

the more the depth of the tree representing the network is limited, the more chance the network has to extend in all directions and the fewer hops there are.

A tree balance criterion emerges from these assumptions.

Knowing n, the depth of the tree representing the network, it is then a question of determining the ideal number of child routers, in order for each router to have the same number of children, to within a tolerance of one. It is also a question of finding the ideal number of levels in order to minimize the depth. Nᵢ denotes the ideal number of abovementioned levels and Rₜ denotes the upper limit value of the desired number of routers for each child, some routers having Rₜ−1 children.

Finally, P denotes the population of routers and N(P) denotes the cardinality of all the routers concerned.

The number of elements of a router tree is given by the corresponding geometrical progression:

$$B ( n , R ) = \frac{1 - {R}^{n}}{1 - R} .$$

This relation denotes the size of a tree for which the number of child routers is given by R and which comprises n levels.

A search is then made for Rₜ, the upper limit value of the number of routers, and nᵢ, the ideal number of levels, by successively calculating the values B(n, R), beginning with n=1 and R=Rₘ, where Rₘ denotes the extreme value of the parameter a.

If B(n,R)<N(P), then the number-of-levels value n must be incremented.

Otherwise nᵢ=n, then the value of R is decremented to the value R=1 or B(nᵢ,R)<N(P).

When B(nᵢ,R)≧N(P) and B(nᵢ,R−1)<N(P), then R=Rₜ, the upper limit value of the desired number of routers for each child node.

It is then possible to implement an adaptation function FF which favors the minimum deviation between the number of child routers of a node and the abovementioned upper limit value Rₜ, for example by calculating for a parent router having R child nodes:

Rₘ−|R−Rₜ|.

A more detailed description of an ad hoc network node or ZigBee network node according to the subject of the present invention, that is, one that makes it possible to implement the method as described previously in the description, will now be given in conjunction with FIGS. 3a and 3b.

As a general rule, it will be recalled that a ZigBee network node, as represented in FIG. 3a, comprises input/output units I/O, naturally enabling the abovementioned node to connect to the ZigBee network concerned, a working memory RAM, a storage memory and a central processing unit CPU.

The storage memory SM can comprise a non-volatile programmable memory divided or not divided into storage modules, as will be described below.

The storage memory can advantageously contain, stored in the latter, a time delay value ΔT on disconnection of the node from the ZigBee network concerned, stored in a module M₁, an order number j for the rebuilding of this network, module M₂ in FIG. 3a, and a logic variable LV, stored in the module M₃, conferring on the node concerned either an aggregator role for LV=0 for example, or a ZigBee coordinator role for LV=1, as described previously in the description.

The elements described in conjunction with the preceding FIG. 3a then make it possible to carry out an approximate rebuilding of the network as described in conjunction with the preceding method and figures.

Furthermore, the ZigBee network node represented in FIG. 3a can advantageously but in a nonlimiting way include a storage module M₄ for storing a list of child nodes of the node concerned, that is the list SNL.

When the list SNL is empty, i.e. SN=[ ], then the ZigBee node concerned can be used to perform an approximate rebuilding. Otherwise, when each ZigBee node includes a non-empty list, i.e. SNL=[A, B, C, D], where A, B, C, D represent the addresses of the child nodes of the node concerned, then the list of the child nodes of the abovementioned node concerned enables the latter to execute an exact rebuilding of the network.

FIG. 3b represents a ZigBee network node including a logic variable LV=1 conferring on the latter a ZigBee coordinator role. In this situation, the node also includes the abovementioned storage modules M₁, M₂, M₃, M₄, and an executable program module M₅ containing a series of instructions enabling the method to be executed as described previously in the description in conjunction with FIGS. 2a to 2h.

It will be understood in particular that the distinction of the structure of a ZigBee network node that is the subject of the present invention, represented in FIGS. 3a and 3b, is introduced purely for illustration as an aid to understanding in order to show the wide flexibility of use of the method that is the subject of the invention, and of implementation of the latter, by simple programming and loading of the abovementioned variable values and parameters. In particular, it will of course be understood that the storage memory SM can comprise a single memory or the separate modules M₁ to M₅ mentioned previously, without departing from the context of the present invention.

Furthermore, the ad hoc or ZigBee network node represented in FIGS. 3a and 3b constitutes a device equipped with a module for collecting data from the nodes of the ad hoc network, in terms of quality of the links and trees of the nodes defining a structure of this network, a module for calculating an optimized network structure and a module for rebuilding this network according to this optimized network structure. The abovementioned device can then, according to an embodiment variant, be included in a predetermined node of a network or, according to another variant, constitute the abovementioned node.

Finally, the invention covers a computer program product stored on a storage medium and executable by a computer or by a dedicated device, noteworthy in that the computer program comprises a series of instructions making it possible to execute the method as described previously in conjunction with the abovementioned FIGS. 2a to 2h. As a nonlimiting example, the abovementioned computer program product stored on a storage medium can be loaded into the module M₅ of a ZigBee network node acting as a coordinator, as represented in FIG. 3b, or ultimately on any external facility network-connected to the ZigBee network and making it possible to execute the stored program as the computer program product mentioned previously. In this case, the abovementioned computer program product can be executed on an external tool directly linked to the node of the network acting as ZigBee coordinator.

1. A method of rebuilding an ad hoc network comprising:
collecting data from nodes of said network, in terms of quality of the links and trees of the nodes defining a structure of said network;
calculating a current optimized structure, from said structure of said network;
evaluating, relative to a stop value, the impact of the current optimized structure on the structure of said network to determine an impact value;
establishing and injecting optimization data into said network, injecting comprising at least transmitting to each node of said network a command including at least one role for the each node;
rebuilding said network according to said current optimized structure;
iteratively repeating the collection of data from the nodes of said network, calculating, evaluating, establishing, injecting, and rebuilding, as long as said stop value is not equal to said impact value; otherwise, if said stop value is equal to said impact value,
stopping the rebuilding method, said network being allocated the current optimized structure obtained on the last iteration, said network thus being optimized.

2. The method as claimed in claim 1 further comprising an automatic triggering step, either on detection of a false distribution signal from a router, or on detection of a false distribution signal from an equipment item, or on an operator command.

3. The method as claimed in claim 1, wherein evaluating includes:
calculating an adaptation score of a tree in the network;
calculating the score of the current optimized structure,
calculating the difference between the adaptation score of the tree and the score of the current optimized structure,
comparing the difference in adaptation with a deviation value, from which the difference in adaptation is considered to be significant, and
maintaining the tree that is in place in the network if this adaptation deviation is less than this deviation value and choosing the current optimized tree structure otherwise.

4. The method as claimed in claim 1, wherein collecting data from the nodes of said network comprises at least:
scanning said network to recover the address of all aggregator nodes present in said network and the links seen by each aggregator node in the neighborhood tables of said aggregator nodes,
creating a first data structure containing all nodes and all links for each node, accompanied by a quality value of each link; and
creating a second data structure restoring the addressing structure of the nodes and their parent node/child node relationship, representing an image of said second data structure and of said network.

5. The method as claimed in claim 1, wherein said calculation of a current optimized structure comprises at least:
calculating a specific adaptation score from an adaptation function for at least a part of said current optimized structure, in the search space of the solution formed by the table of the links involved between all the nodes of said network, in order to create a population of individuals formed by a plurality of optimized structures, with each of which is associated a specific adaptation score;
enhancing said population, on a specific criterion for discriminating individuals to generate an enhanced population; and
selecting from said enhanced population of a specific structure presenting the best adaptation score as the current optimized structure.

6. The method as claimed in claim 1, wherein the impact evaluation step comprises at least, for the image of the structure of said network and for each current optimized structure, in calculating, using said adaptation function, a distance value, the deviation between the adaptation score of the image of the structure of said network and the adaptation score of each current optimized structure; and if the value of said deviation is less than a significant difference value,
retaining the structure of said network as the current optimized structure; otherwise if the value of said deviation is greater than said meaningful difference value, and
replacing said structure of said network with said current optimized structure.

7. The method as claimed in claim 1, wherein said stop value is a value dependent on the deviation between an adaptation score of the image of the structure of said network and an adaptation score of the current optimized structure.

8. The method as claimed in claim 1, wherein the command transmitted to each node of said network includes at least:
a time delay before disconnecting from the network;
an order number j for the rebuilding of the network; and
an aggregator, router or coordinator role.

9. The method as claimed in claim 8, wherein for an exact rebuilding of said network, said command also comprises information containing the list of the child routers of the recipient node, constituting a parent node in the current optimized structure.

10. The method as claimed in claim 1, wherein on receipt of said command by each node,
said node observes a time delay before any disconnection; and, if said node is assigned a coordinator role,
said node establishes said optimized network, from said non-optimal network; otherwise, and
said node observes another time delay then connects as router.

11. The method as claimed in claim 1, wherein for an exact rebuilding, each parent node having the address of its pre-registered child nodes, when they are activated after a predetermined delay,
each node searches for the parent node with which it is preregistered as a child node; and, on successfully searching for and identifying the parent node,
each child node connects to said parent node; otherwise, in the absence of a response from said parent node, then
each child node connects to another node of said network, by an association procedure.

12. An ad hoc network node comprising input/output devices, a working memory, a storage memory and a central processing unit, said node comprising at least, stored in said storage memory;
a time delay value on disconnecting this node from this network;
an order number for the rebuilding of this network; and
a logic variable giving said node either an aggregator role, or a coordinator role, which enables said node to execute an approximate rebuilding of said network.

13. The network node as claimed in claim 12, in wherein, stored in said storage memory, is a list of child nodes of said node, which enables said node to execute an exact rebuilding of said network.

14. The network node as claimed in claim 12, wherein, for a logic variable conferring a coordinator role on said node, said node also includes, stored in said storage memory, an executable program module comprising a series of instructions for rebuilding an ad hoc network, in which said instructions include:
collecting data from the nodes of said network, in terms of quality of the links and trees of the nodes defining a structure of said network;
calculating a current optimized structure, from said structure of said network;
evaluating, relative to a stop value, the impact of the current optimized structure on the structure of said network to determine an impact value;
establishing and injecting optimization data into said network, injection comprising the transmission to each node of said network of a command including at least one role for the node;
rebuilding of said network according to said current optimized structure;
iteratively repeating the collection of data from the nodes of said network and the calculation, evaluation, establishment, injection and rebuilding steps, as long as said stop value is not equal to the impact value; otherwise, if said stop value is equal to said impact value,
stopping the rebuilding method, said network being allocated the current optimized structure obtained on the last iteration, said network thus being optimized.

15. (canceled)

16. A computer program produce stored on a storage medium and executable by a computer or by a dedicated device, wherein said computer program comprises a series of instructions to execute the method as claimed in claim 1.
